(19) United States
(12) Patent Application Publication
(10) Pub. No.: US 2011/0061753 A1
(43) Pub. Date: Mar. 17, 2011

(54) Split-Type Valve Seat For A Faucet

(75) Inventors: Liming Ye, Xiamen (CN); Bentai Chen, Xiamen (CN)

(73) Assignee: Xiamen Lota International Co., Ltd., Xiamen (CN)

(21) Appl. No.: 12/652,121

(22) Filed: Jan. 5, 2010

(30) Foreign Application Priority Data
Sep. 17, 2009 (CN) 2009201830061

(51) Int. Cl. F16K 11/00

(52) U.S. Cl. 137/625.4

(57) ABSTRACT

The inventive valve seat for a faucet includes a one-piece plastic valve seat body, a metal cover and a flange. The metal cover is set outside the valve seat body and is fixed to the valve seat body by the flange. The valve seat is environmentally friendly, and of light weight and low materials cost. Since the metal cover has high strength and is combined with a plastic valve seat body, it can bear the substantial forces imposed upon the valve seat.

### TECHNICAL FIELD

The present invention relates to a valve seat for a faucet, especially a split-type valve seat.

### BACKGROUND OF THE INVENTION

The water control assembly of a faucet is typically fixed to a valve seat by a fixed block. The faucet handle only can control the water control assembly after the valve seat is fixed to the basin. Therefore, the valve seat bears all the force imparted upon the faucet cartridge. If the strength of the valve seat is inadequate, the valve seat is prone to break in the process of installation and usage. Therefore, the valve seat for a faucet is typically made by true copper materials and formed to be one-piece by casting and forging. The strength of such a valve seat is high. However, the cost of using true copper materials is high. Moreover, the copper valve seat also contains heavy metals, such as Pb and Cd. Harmful heavy metals (such as Pb and Cd) will be released into the water after long usage. These metals will pollute the water and be harmful to human beings. The presence of such metals in water is inconsistent with environment protection.

### SUMMARY OF THE INVENTION

The present invention is directed to a split-type valve seat for a faucet, having the features of low manufacturing cost, high strength and non-toxicity.

The present split-type valve seat for a faucet includes a one-piece plastic valve seat body, a metal cover and a flange. The metal cover is set outside the valve seat body and is fixed to the valve seat body by the flange.

The two ends of the plastic valve seat body separately include a threaded portion. A collar flange whose diameter is slightly larger than the outer diameter of the valve seat body is formed below the upper threaded portion of the plastic valve seat body. The outer edge of the valve seat body has several ribs. A water outlet hole is formed between the ribs and the lower threaded portion of the plastic valve seat body.

The entire outer wall of the metal cover includes an external thread. Several grooves which are coupled to the ribs of the valve seat body are formed in the inner wall of the lower portion of the metal cover.

The inventive split-type valve seat for a faucet includes a plastic valve seat body and a metal cover. It features an environmentally friendly construction, light weight and low materials cost. Since the metal cover has high strength and is combined with the plastic valve seat body, it can bear all the force given to the valve seat, and meets the requirements of practicality and environmental protection.

### BRIEF DESCRIPTION OF THE DRAWINGS

To understand the present invention, it will now be described by way of example, with reference to the accompanying drawings in which:

FIG. 1 is an exploded view of the inventive valve seat for a faucet, showing the various components of the valve seat;

FIG. 2 is a section view of FIG. 1, but in an assembled condition;

FIG. 3 is a perspective view of FIG. 1, but in an assembled condition;

FIG. 4 is a section view taken along line “D-D” of FIG. 2;

FIG. 5 is an exploded view of a faucet with the inventive valve seat; and

FIG. 6 is a perspective view of a faucet with the inventive valve seat in a use position.

The components in the drawings are not necessarily to scale, emphasis instead being placed upon clearly illustrating the principles of the present invention.

### DETAILED DESCRIPTION

While this invention is susceptible of embodiments in many different forms, there is shown in the drawings and will herein be described in detail preferred embodiments of the invention. The present disclosure is to be considered as an exemplification of the principles of the invention. The disclosure is not intended to limit the broad aspect of the invention to the embodiments illustrated.

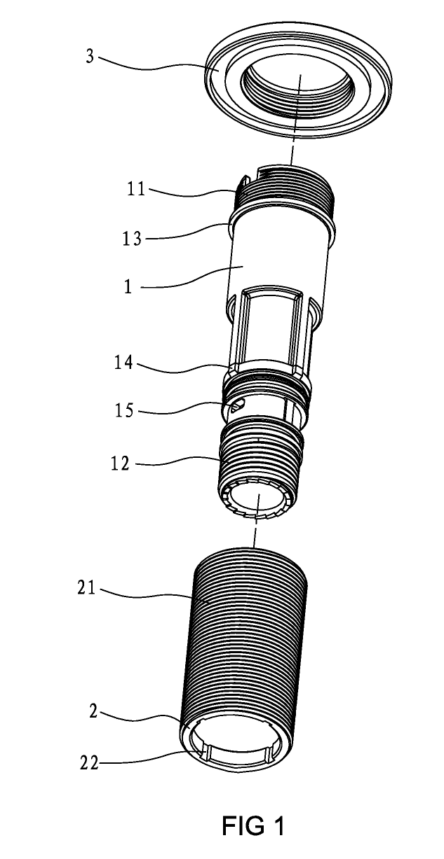

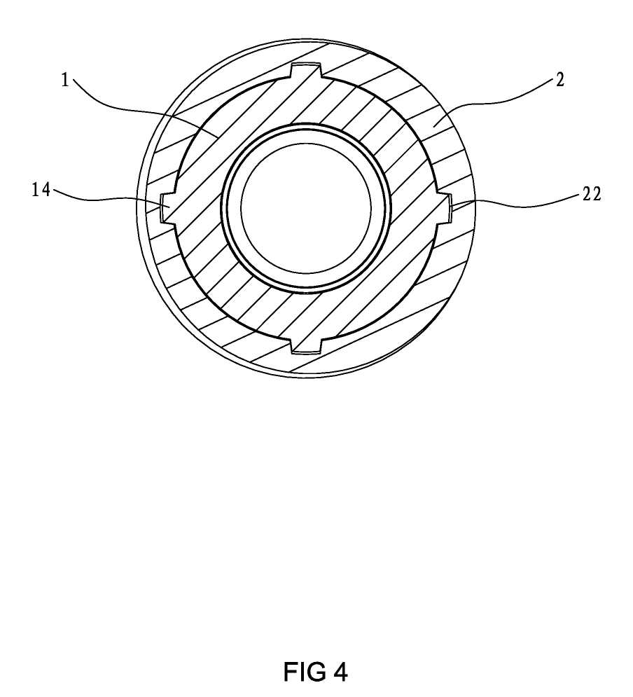

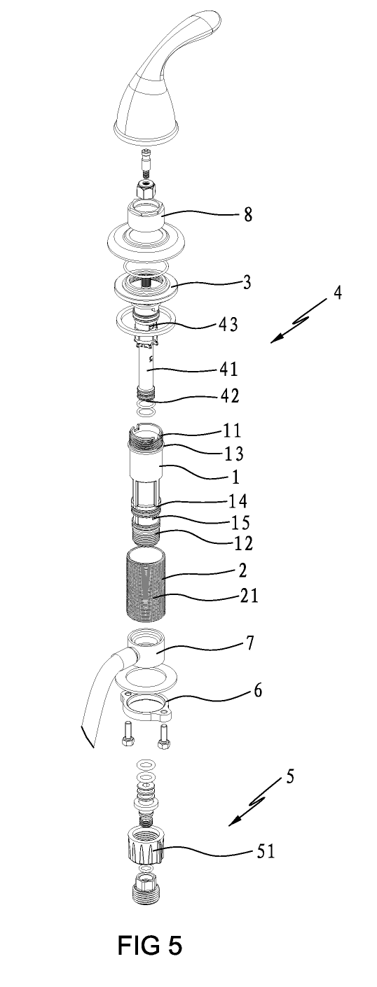

As seen in FIGS. 1, 3 and 4, the inventive split-type valve seat for a faucet includes a one-piece plastic valve seat body 1, a metal cover 2 and a flange 3. The valve seat body 1 is made of plastic, to be of one-piece construction. The two ends of the plastic valve seat body 1 separately include a threaded portion 11 and 12. The upper threaded portion 11 is connected to a fixed block 8 so that the water control assembly 4 (as seen in FIG. 5) is tightly fixed to the valve seat body 1. The lower threaded portion 12 is coupled to the water inlet assembly 5. A collar flange 13 whose diameter is slightly larger than the external diameter of the valve seat body 1 is formed below the upper threaded portion 11 of the plastic valve seat body 1. The outer edge of the valve seat body 1 has several ribs 14. A water outlet hole 15 is formed between the ribs 14 and the lower threaded portion 12 of the plastic valve seat body 1.

The whole outer wall of the metal cover 2 has an external thread 21. Several grooves 22 which are coupled to the ribs 14 of the valve seat body 1 are formed in the inner wall of the lower portion of the metal cover 2. The grooves 22 are coupled to the ribs 14 so that the metal cover 2 is tightly fixed to the valve seat body 1 and won't radially move between them.

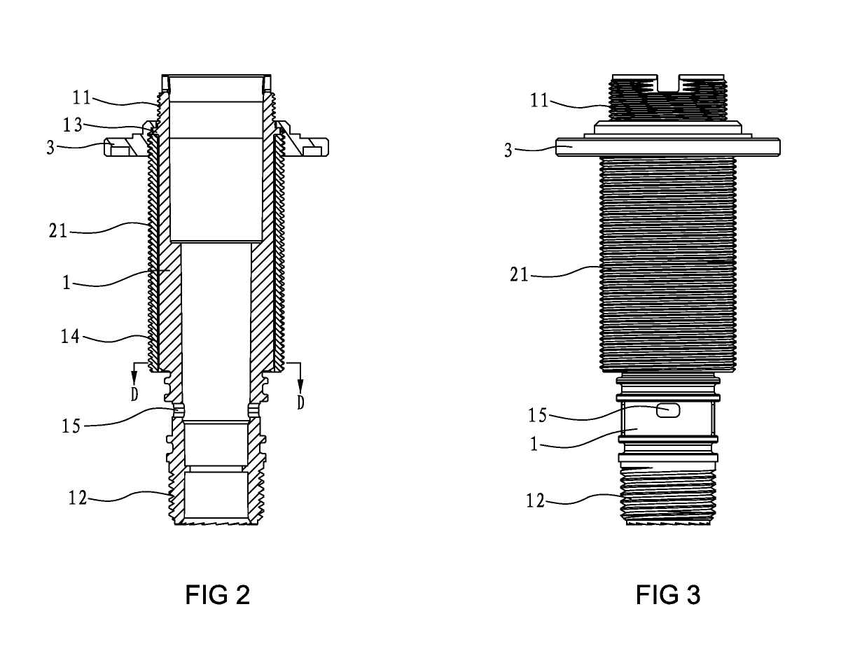

In an assembled position, the metal cover 2 is set outside the valve seat body 1. The grooves 22 of the metal cover 2 are coupled to the ribs 14 of the valve seat body 1. The upward movement of the metal cover 2 is limited by the collar flange 13 of the valve seat body 1. The metal cover 2 is fixed to the collar flange 13 of the valve seat body 1 by the internal thread of the flange 13, as seen in FIG. 2.

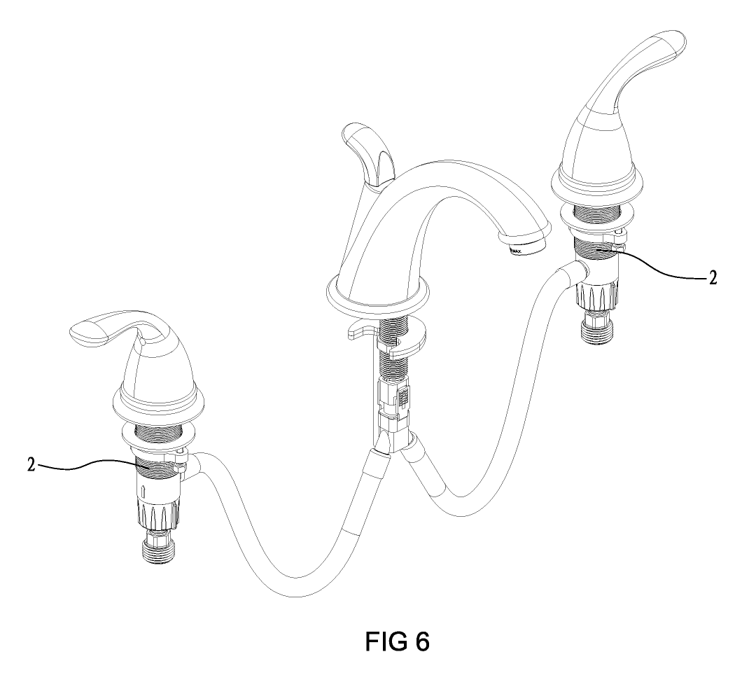

In a use position, the inventive valve seat for a faucet is coupled to a water control assembly 4 and forms flow paths between them, as seen in FIGS. 5 and 6. The water control assembly 4 is fixed in the valve seat body 1 by the fixed block 8. A water inlet assembly 5 is connected to the water inlet 42 of the cartridge 41 of the water control assembly 4 and is fixed to the lower threaded portion 12 of the plastic valve seat body 2 by a nut 51. Therefore, the water inlet assembly 5 is firmly connected to the water control assembly 4.

The metal cover 2 is fixed to the basin by a locking piece 6. The flow path is from the water inlet assembly 5 into the cartridge 41. If the water control assembly is in an open position, the water will flow from the cartridge 41 into the valve seat body 1 via the water inlet 43 in the cartridge 41. Then the water will flow from the flow path which is formed between the inner wall of the valve seat body 1 and the cartridge 41 to the water outlet conduit 7 via the water outlet hole 15 in the lower portion of the valve seat body 1.

The inventive valve seat includes a one-piece plastic valve seat body, a metal cover and a flange. The valve seat is environmentally friendly, lightweight and has low-cost materials and low manufacturing costs. Since the metal cover has high strength and is combined with a plastic valve seat body, it can bear all the force given to the valve seat, and is more practical.

What is claimed is:

1. A split-type valve seat for a faucet comprising:
a one-piece plastic valve seat body, a metal cover and a flange;
a fixed block connected to the upper end of the plastic valve seat body so that a water control assembly is tightly fixed to the valve seat body; and
a water outlet hole formed in the lower portion of the plastic valve seat body.

2. The split-type valve seat for a faucet of claim 1, wherein there are ribs on the valve seat body and several longitudinal grooves formed on the inner walls of the lower portion of the metal cover, so that when the plastic valve seat body is placed within the confines of the metal cover, the ribs of the plastic valve seat body are accommodated by these grooves so as to tightly seat the plastic valve seat body to the metal cover.

3. The split-type valve seat for a faucet of claim 1, wherein the flange secures the metal cover to the valve seat body.

4. The split-type valve seat for a faucet of claim 1, wherein a collar flange, whose diameter is slightly larger than the outer diameter of the valve seat body, is formed in the upper portion of the plastic valve seat body.

5. The split-type valve seat for a faucet of claim 1, further comprising external threads around the exterior of the metal cover.

6. The split-type valve seat for a faucet of claim 1, further comprising threaded portions on two opposite ends of the plastic valve seat body.
